(19) United States
(12) Patent Application Publication
(10) Pub. No.: US 2021/0241628 A1
(43) Pub. Date: Aug. 5, 2021

(54) MANAGEMENT APPARATUS, MANAGEMENT METHOD, AND VEHICLE

(71) Applicant: HONDA MOTOR CO., LTD., Tokyo (JP)

(72) Inventors: Masaru Otaka, Wako-shi (JP); Ryusuke Tamanaha, Wako-shi (JP); Yusuke Oi, Tokyo (JP); Takahiro Iijima, Tokyo (JP); Naoko Imai, Wako-shi (JP)

(73) Assignee: HONDA MOTOR CO., LTD., Tokyo (JP)

(21) Appl. No.: 17/164,955

(22) Filed: Feb. 2, 2021

(30) Foreign Application Priority Data
Feb. 5, 2020 (JP) 2020-018183

(51) Int. Cl. G08G 1/00; H04W 4/46; H04W 84/18; H04W 4/08; H04W 60/04

(52) U.S. Cl. CPC G08G 1/22; H04W 4/46; H04W 60/04; H04W 4/08; H04W 84/18

(57) ABSTRACT

A management apparatus for managing a communication group composed of a plurality of vehicles that each include a communication apparatus is provided. The management apparatus obtains vehicle information related to two or more vehicles included in one communication group, and based on the vehicle information related to the two or more vehicles, reorganizes each of the two or more vehicles into one of two or more communication groups.

This application claims priority to and the benefit of Japanese Patent Application No. 2020-018183 filed on Feb. 5, 2020, the entire disclosure of which is incorporated herein by reference.

### BACKGROUND OF THE INVENTION

### Field of the Invention

The present disclosure relates to a management apparatus, a management method, and a vehicle.

### Description of the Related Art

A technique is known that configures a communication group for performing multi-hop communication among a plurality of vehicles that include communication apparatuses. A vehicle that belongs to the communication group may connect to an external network via a communication link to another vehicle within the same communication group.

If the distance between vehicles within a communication group increases as a result of, for example, the vehicles taking separate courses, a communication link between the vehicles is disconnected. In this case, transmission and reception of data may disrupted due to the inability to continue multi-hop communication.

### SUMMARY OF THE INVENTION

The present disclosure provides a technique to improve the continuity of communication within a communication group of vehicles. According to one aspect, provided is a management apparatus for managing a communication group composed of a plurality of vehicles that each include a communication apparatus, the management apparatus comprising: a memory for storing computer readable code; and a processor operatively coupled to the memory, the processor configured to: obtain vehicle information related to two or more vehicles included in one communication group; and based on the vehicle information related to the two or more vehicles, reorganize each of the two or more vehicles into one of two or more communication groups.

### BRIEF DESCRIPTION OF THE DRAWINGS

FIG. 1 is a schematic diagram illustrating examples of configurations of communication groups according to an embodiment of a part of the present disclosure.

FIG. 2 is a block diagram illustrating an example of a hardware configuration of a vehicle according to an embodiment of a part of the present disclosure.

FIG. 3 is a block diagram illustrating an example of a functional configuration of a vehicle according to an embodiment of a part of the present disclosure.

FIG. 4 is a flow diagram illustrating examples of operations of a vehicle that is outside a communication group according to an embodiment of a part of the present disclosure.

FIG. 5 is a flow diagram illustrating examples of operations of a vehicle that is outside a communication group according to an embodiment of a part of the present disclosure.

FIG. 6 is a flow diagram illustrating examples of operations of a management apparatus according to an embodiment of a part of the present disclosure.

FIG. 7 is a flow diagram illustrating examples of operations of a management apparatus according to an embodiment of a part of the present disclosure.

FIG. 8 is a flow diagram illustrating reorganization of a group according to an embodiment of a part of the present disclosure.

FIG. 9 is a schematic diagram illustrating an example of reorganization of groups according to an embodiment of a part of the present disclosure.

FIG. 10 is a schematic diagram illustrating an example of a method of determining a root node according to an embodiment of a part of the present disclosure.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

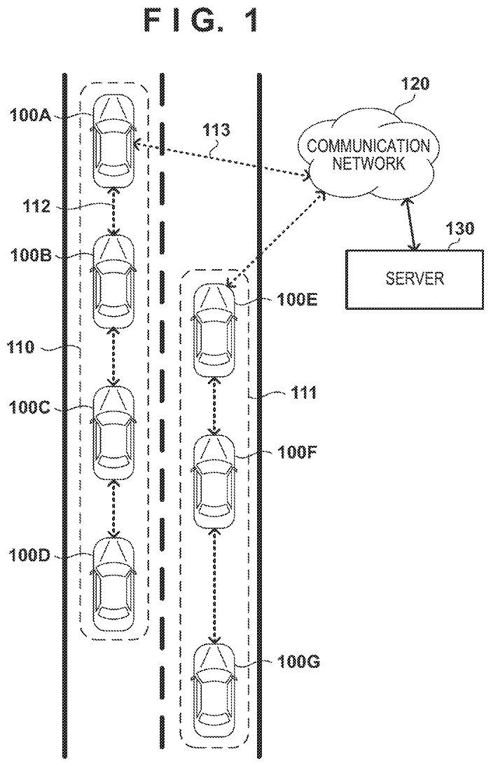

With reference to FIG. 1, the following describes examples of communication groups composed of a plurality of vehicles that each include a communication apparatus. In the examples of FIG. 1, one communication group 110 is composed of four vehicles 100A to 100D, and another communication group 111 is composed of three vehicles 100E to 100G. Each of the vehicles 100A to 100G includes a communication apparatus. A communication apparatus of a vehicle may be a communication apparatus installed in the vehicle, or may be a communication apparatus that is temporarily brought to the vehicle (e.g., a mobile telephone of a person on board the vehicle).

Vehicles within a communication group are capable of communicating directly with one or more of vehicles within the same communication group. For example, the vehicle 100B in the communication group 110 is capable of communicating with the vehicle 100A in the same communication group 110 via a communication link 112. Furthermore, the vehicle 100B is also capable of communicating with another vehicle 100C in the same communication group 110 via a communication link different from the communication link 112. A communication link between vehicles (e.g., the communication link 112) may be a communication link based on vehicle-to-vehicle communication conforming to, for example, ARIB (the Association of Radio Industries and Businesses) STD-T109, or may be a communication link that uses wireless LAN (Local Area Network) technology, such as Wi-Fi™. In the foregoing manner, communication apparatuses of a plurality of vehicles that compose one communication group form an ad hoc network.

Among a plurality of vehicles that belong to a communication group, one vehicle representatively communicates with an external communication network 120. Such a vehicle that communicates with the external communication network 120 is referred to as a root node of the communication group. The “external communication network” denotes a communication network other than the communication apparatuses of the vehicles that belong to the communication group. For example, the communication network 120 may be the Internet. A root node may connect to the communication network 120 via cellular communication or via road-to-vehicle communication.

Among a plurality of vehicles that belong to a communication group, vehicles other than a root node connect to the communication network 120 via the root node and, in some cases, another vehicle. For example, assume that a root node of the communication group 110 is the vehicle 100A. The vehicle 100A communicates with the communication network 120 via a communication link 113. The vehicle 100B connects to the communication network 120 via the vehicle 100A, rather than communicating directly with the communication network 120. Specifically, the vehicle 100B connects to the communication network 120 via the communication link 112 and the communication link 113. In this manner, vehicles other than the root node communicate with the communication network 120 with use of multi-hop communication.

Among a plurality of vehicles that belong to a communication group, one vehicle functions as a management apparatus that manages this communication group. In the following description, it is assumed that a vehicle that acts as a root node functions as a management apparatus. For example, the vehicle 100A functions as a management apparatus in the communication group 110, and the vehicle 100E functions as a management apparatus in the communication group 111. Alternatively, a vehicle other than a root node may function as a management apparatus. Furthermore, a communication apparatus that does not belong to a communication group, for example, a server 130 connected to the communication network 120, may function as a management apparatus.

A connection configuration of a plurality of vehicles within a communication group may be series as shown in FIG. 1. Alternatively, the connection configuration may be a tree structure in which a root node acts as a root. The vehicles 100A to 100D are traveling in the same lane toward the same direction. Therefore, even if the respective geographical positions of the vehicles 100A to 100D change, the communication links within the communication group 110 are maintained.

With reference to FIG. 2, the following describes an example of a hardware configuration of a vehicle 100. FIG. 2 mainly illustrates constituent elements related to an embodiment described below. Constituent elements related to traveling of the vehicle 100 (e.g., an engine, a power train, and so forth) may be existing constituent elements, and thus a description thereof is omitted. The vehicle 100 may include constituent elements shown in FIG. 2.

A control apparatus 200 controls an entirety of the vehicle 100. The control apparatus 200 is realized by, for example, one or more ECUs (Electronic Control Units). The control apparatus 200 may include a processor 201 and a memory 202. The processor 201 executes various computations. The memory 202 stores data that is necessary for processing of the processor 201. The memory 202 is realized by, for example, a ROM (Read Only Memory), a RAM (Random Access Memory), or a disk drive. The operations of the control apparatus 200 may be executed by the processor 201 executing a program stored in the memory 202. Alternatively, a part or all of the operations of the control apparatus 200 may be realized by a dedicated circuit, such as an ASIC (Application Specific Integrated Circuit) and an FPGA (Field Programmable Gate Array).

An input apparatus 203 is an apparatus for receiving an input from a person on board the vehicle 100 (e.g., a driver). The input apparatus 203 is realized by, for example, a button, a touchscreen, and the like. Furthermore, the input apparatus 203 may include a sound input apparatus.

An output apparatus 204 is an apparatus for providing an output to a person on board the vehicle 100 (e.g., a driver). The output apparatus 204 is realized by, for example, a liquid crystal display, a speaker, instruments, and the like.

A positioning apparatus 205 is an apparatus for measuring a current geographical position of the vehicle 100. The positioning apparatus 205 is realized by, for example, a GPS (Global Positioning System) sensor. A vehicle speed sensor 206 is a sensor for measuring a current speed of the vehicle 100. The vehicle speed sensor 206 may be, for example, a vehicle wheel speed sensor.

The communication apparatus 207 is an apparatus for communicating with another communication apparatus. The communication apparatus 207 may communicate with a vehicle located around the vehicle 100, and communicate with other apparatuses (e.g., a base station and an access point of a cellular network, a communication apparatus placed on a road, and so forth).

A camera 208 is an apparatus that shoots an environment surrounding the vehicle 100. The camera 208 may include a camera that shoots the inside of a vehicle room of the vehicle 100. The control apparatus 200 may specify a lane in which the vehicle 100 is currently traveling (which one of a plurality of lanes) based on an image of the surrounding environment shot by the camera 208. Furthermore, the control apparatus 200 may determine the number of people on board the vehicle 100 based on an image of the inside of the vehicle room shot by the camera 208.

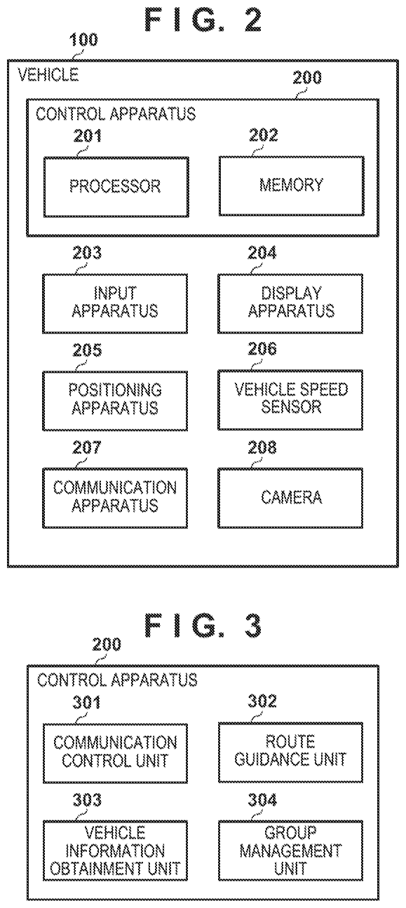

With reference to FIG. 3, the following describes an example of a functional configuration of the vehicle 100. Constituent elements shown in FIG. 3 are executed by, for example, the control apparatus 200. A communication control unit 301 controls communication that uses the communication apparatus 207. Communication performed by the communication control unit 301 may include communication that is performed directly with a vehicle around the vehicle 100, and communication that is performed with the communication network 120 either directly or via another vehicle.

A route guidance unit 302 generates a route to a destination that has been designated by a person on board the vehicle 100. This route is determined based on, for example, map information stored in the memory 202 and a current position measured by the positioning apparatus 205. Using the output apparatus 204, the route guidance unit 302 provides the route to the destination to a driver. While the vehicle 100 is traveling through automated driving, the route guidance unit 302 provides the route to the destination to a travel control unit (not shown), and the travel control unit performs automated travel control along this route.

A vehicle information obtainment unit 303 obtains information related to the vehicle 100. Hereinafter, information related to the vehicle 100 is referred to as vehicle information. The vehicle information may include, for example, information related to a course of the vehicle, information related to a position of the vehicle, information related to a speed of the vehicle, information related to the communication apparatus included in the vehicle, information related to a person on board the vehicle, and information related to a type of the vehicle.

The information related to the course of the vehicle may include, for example, a moving direction at a branch in a road (going straight, turning right, or turning left), and a route to a destination of the vehicle. The information related to the course of the vehicle may be estimated from a history of behaviors of the vehicle in the past, may be determined based on an input via a direction indicator, or may be determined by the route guidance unit 302.

The information related to the position of the vehicle may include an area to which a current geographical position of the vehicle belongs, and a lane in which the vehicle is located. The information related to the speed of the vehicle may include a current speed of the vehicle and a speed of the vehicle in the past (e.g., an average speed in the last hour).

The information related to the communication apparatus included in the vehicle may include a communication capacity of the communication apparatus of the vehicle and information related to a radio wave band used by the communication apparatus. The information related to the person on board the vehicle may include the number of people on board and the composition of people on board (e.g., variation in age). The information related to the type of the vehicle may include a vehicle category of the vehicle (e.g., a truck or a passenger vehicle).

The vehicle information obtained by the vehicle information obtainment unit 303 may be all of the foregoing specific examples, or may be only a part of the foregoing specific examples.

A group management unit 304 provides a function for enabling the vehicle 100 to operate as a management apparatus in a communication group. Each one of the vehicles that belong to the communication group may include the group management unit 304, or only a part of such vehicles may include the group management unit 304. A vehicle that does not include the group management unit 304 may not be capable of operating as a management apparatus in the communication group.

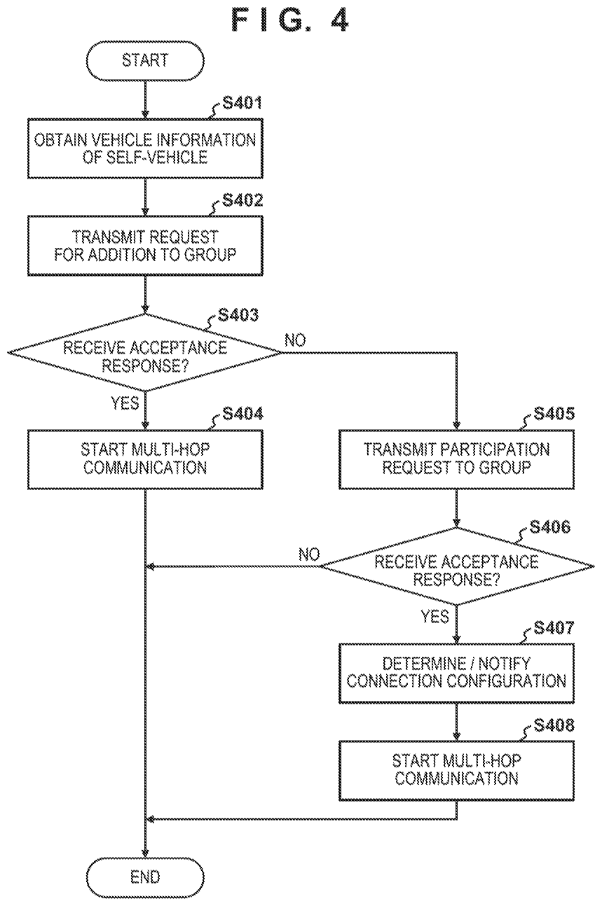

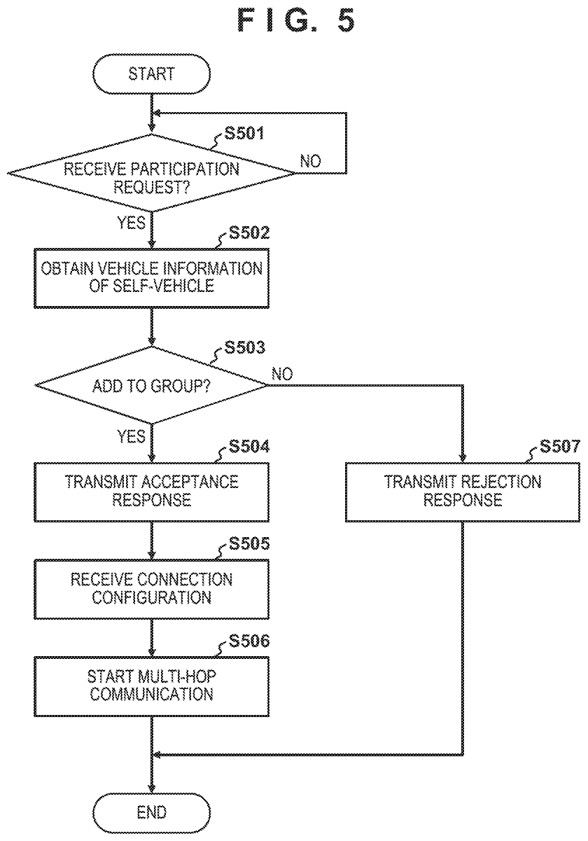

With reference to FIG. 4 to FIG. 8, the following describes examples of operations of a vehicle related to a communication group. FIG. 4 shows examples of operations for enabling a vehicle that does not belong to a communication group to belong to a communication group. The operations of FIG. 4 may be executed by the control apparatus 200 (specifically, the communication control unit 301) of a vehicle 100. The operations of FIG. 4 are started when, for example, a person on board the vehicle 100 has issued an instruction for belonging to a communication group (i.e., for entering a state where multi-hop communication may be performed).

In step S401, the control apparatus 200 obtains vehicle information of the self-vehicle. Specific examples of the vehicle information obtained here are as described above.

In step S402, the control apparatus 200 transmits, to a surrounding vehicle, a request for addition to a communication group. The request for addition to the communication group is a request to add the self-vehicle to an existing communication group. The control apparatus 200 includes the vehicle information obtained in step S401 in this request for addition. The request for addition may be transmitted by broadcast transmission. Alternatively, the request for addition may be transmitted via a communication link that has been established with a communication apparatus of the surrounding vehicle.

In step S403, the control apparatus 200 determines whether a response indicating acceptance of participation in the communication group has been received from a management apparatus in the communication group. When the response indicating acceptance has been received (“YES” of step S403), the control apparatus 200 causes processing to proceed to step S404; otherwise (“NO” of step S403), processing proceeds to step S405. The response indicating acceptance may include a connection configuration of the communication group. When the response indicating acceptance does not include the connection configuration, the control apparatus 200 may separately request the management apparatus that transmitted the response indicating acceptance for the connection configuration. The connection configuration of the communication group includes information for enabling multi-hop communication to be performed among vehicles that belong to the communication group. For example, the connection configuration may include communication addresses of respective vehicles that belong to the communication group.

When the response indicating acceptance has been received from a plurality of communication groups in step S403, the control apparatus 200 selects one communication group to which the self-vehicle is to belong. This selection may be made randomly, or may be made based on the vehicle information of the self-vehicle. For example, the control apparatus 200 obtains, from the management apparatuses in the plurality of communication groups, pieces of vehicle information of these management apparatuses, and compares the pieces of vehicle information of the management apparatuses with the vehicle information of the self-vehicle. Based on the result of comparison, the control apparatus 200 may select a communication group to which the self-vehicle is expected to be able to belong for the longest period.

In step S404, the control apparatus 200 starts multi-hop communication in accordance with the connection configuration received in step S403. When the self-vehicle is a root node, the control apparatus 200 also starts operations as a management apparatus in the communication group to which the self-vehicle belongs.

In step S405, the control apparatus 200 transmits, to a surrounding vehicle, a request for participation in a communication group. This step is performed when participation in an existing communication group has failed. In view of this, the control apparatus 200 aims to form a new communication group. The control apparatus 200 includes the vehicle information obtained in step S401 in this request for addition. The request for participation may be transmitted by broadcast transmission to the surroundings of the vehicle. Alternatively, the request for participation may be transmitted via a communication link that has been established with a communication apparatus of the surrounding vehicle.

In step S406, the control apparatus 200 determines whether a response indicating acceptance of participation in the communication group has been received from the surrounding vehicle. When the response indicating acceptance has been received (“YES” of step S406), the control apparatus 200 causes processing to proceed to step S407; otherwise (“NO” of step S406), processing is ended. When processing is ended, as the vehicle 100 cannot belong to a communication group, the control apparatus 200 may notify a person on board to that effect.

In step S407, the control apparatus 200 constructs a communication group that includes the self-vehicle and one or more vehicles from which the response indicating acceptance was received in step S406, and determines a connection configuration of this communication group. The control apparatus 200 notifies each vehicle in the communication group of the determined connection configuration. A method of determining a connection configuration of a communication group will be described later.

In step S408, the control apparatus 200 starts multi-hop communication in accordance with the connection configuration determined in step S407. When the self-vehicle is a root node, the control apparatus 200 also starts operations as a management apparatus in the communication group to which the self-vehicle belongs.

FIG. 5 shows examples of operations for a case where a vehicle that does not belong to a communication group has received a request for belonging to a communication group from another vehicle. The operations of FIG. 5 may be executed by the control apparatus 200 (specifically, the communication control unit 301) of a vehicle 100. The operations of FIG. 5 are, for example, executed continuously while the communication apparatus 207 of the vehicle 100 is ON.

In step S501, the control apparatus 200 determines whether a participation request has been received from another vehicle. When the participation request has been received (“YES” of step S501), the control apparatus 200 causes processing to proceed to step S502; otherwise (“NO” of step S501), step S501 is repeated. The participation request is the participation request transmitted in step S405.

In step S502, the control apparatus 200 obtains vehicle information of the self-vehicle. Specific examples of the vehicle information obtained here are as described above.

In step S503, the control apparatus 200 determines whether to participate in a communication group. To participate in the communication group (“YES” of step S503), the control apparatus 200 causes processing to proceed to step S504; otherwise (“NO” of step S503), processing proceeds to step S507. Whether to participate in the communication group is determined by comparing the vehicle information of the self-vehicle with vehicle information included in the participation request received in step S501 (i.e., vehicle information of the vehicle that issued the participation request). For example, the control apparatus 200 may accept to participate in the communication group when the future courses of the two vehicles to be compared with each other (e.g., 30-minute courses or 50-kilometer courses to be taken from a current geographical point) are the same. Furthermore, the control apparatus 200 may regard a state where the two vehicles are located in the same lane as a condition for participating in the group. In addition, the control apparatus 200 may regard a state where a difference between the speeds of the two vehicles (e.g., the current speeds or the average speeds in the past) are within a predetermined range (e.g., equal to or lower than 5 km per hour) as a condition for participating in the group.

When it is determined that participation in the communication group is to be made, the control apparatus 200 transmits, to the vehicle that transmitted the participation request, an acceptance response indicating participation in the communication group in step S504. On the other hand, when it is determined that participation in the communication group is not to be made, the control apparatus 200 transmits, to the vehicle that transmitted the participation request, a rejection response indicating no participation in the communication group in step S507.

In step S505, the control apparatus 200 receives a connection configuration of the communication group from another vehicle. In step S506, the control apparatus 200 starts multi-hop communication in accordance with the connection configuration received in step S505. When the self-vehicle is a root node, the control apparatus 200 also starts operations as a management apparatus in the communication group to which the self-vehicle belongs.

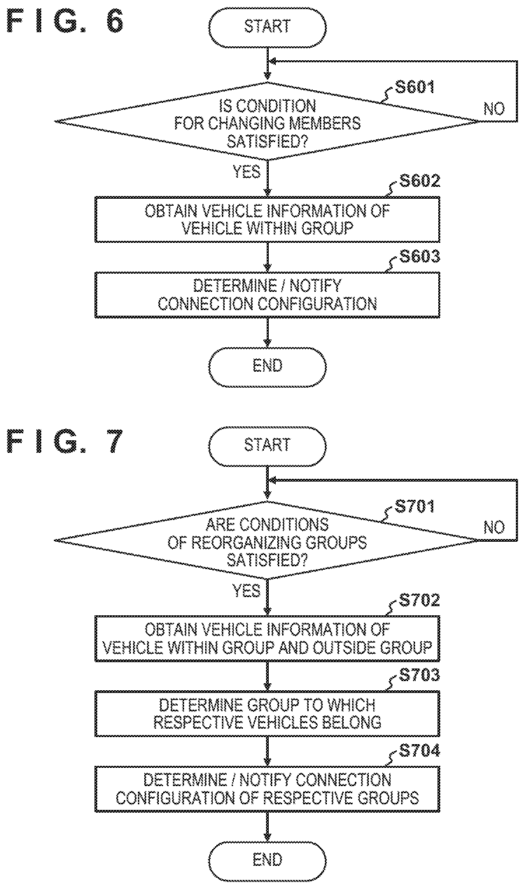

FIG. 6 shows examples of operations for changing members of a communication group. Members of a communication group refer to vehicles that belongs to the communication group. The control apparatus 200 (specifically, the group management unit 304) of a vehicle 100 that functions as a management apparatus in the communication group repeatedly executes the operations shown in FIG. 6 while belonging to the communication group.

In step S601, the control apparatus 200 determines whether a condition for changing members of the communication group is satisfied. Hereinafter, this condition will be referred to as a changing condition. When the changing condition is satisfied (“YES” of step S601), the control apparatus 200 causes processing to proceed to step S602; otherwise (“NO” of step S601), step S601 is repeated.

For example, the changing condition may include a state where it has been determined that the vehicle that transmitted the request for addition in step S402 is to participate in the communication group. First, when the communication group has no room for adding a new vehicle, the control apparatus 200 rejects the participation. Whether the communication group has room for adding a new vehicle may be determined based on the current number of vehicles in the communication group, the maximum number of hops in the communication group, and a communication capacity of a root node. When the communication group has room for adding a new vehicle thereto, the control apparatus 200 compares vehicle information included in the request for addition with vehicle information of the self-vehicle to determine whether to allow the vehicle that issued the request to participate in the communication group. Specifically, the control apparatus 200 makes this determination in a manner similar to the above-described participation in a communication group in step S503.

The changing condition may include the incapability to communicate with one of a plurality of vehicles that belong to the communication group within the communication group. In order to make a determination about this condition, the control apparatus 200 may periodically check whether communication with each vehicle within the communication group is possible. Furthermore, the changing condition may include a state where a notification indicating the withdrawal from the communication group has been received from one of the plurality of vehicles that belong to the communication group.

In step S602, the control apparatus 200 obtains pieces of vehicle information of respective members (respective vehicles) in the communication group after the change. To this effect, the control apparatus 200 may request respective members to provide the pieces of vehicle information, and respective members may respond with the pieces of vehicle information.

In step S603, based on the self-vehicle and one or more pieces of vehicle information obtained in step S602, the control apparatus 200 determines a connection configuration of the communication group after the member change. The control apparatus 200 notifies each vehicle in the communication group of the determined connection configuration. A method of determining a connection configuration of a communication group will be described later. Upon receiving the notification of the connection configuration, each vehicle starts multi-hop communication in accordance with this connection configuration. The control apparatus 200 of a vehicle 100 that acts as a root node also starts operations as a management apparatus in the communication group to which the self-vehicle belongs.

FIG. 7 shows examples of operations for reorganizing communication groups. The control apparatus 200 (specifically, the group management unit 304) of a vehicle 100 that functions as a management apparatus in a communication group repeatedly executes the operations shown in FIG. 7 while belonging to a communication group. Reorganizing communication groups means to change one or more communication groups into two or more communication groups. By reorganizing communication groups, each of two or more vehicles included in one communication group is reorganized into one of two or more communication groups. Reorganization whereby one communication group is changed into two or more communication groups may also be referred to as division of a communication group.

If a vehicle that belongs to a communication group becomes no longer capable of communicating with a root node, this vehicle needs to search for a communication group to which it is to newly belong. Therefore, communication is disconnected until multi-hop communication in the new communication group is started. On the other hand, according to an embodiment of a part of the present disclosure, a vehicle, while belonging to a communication group, is reorganized into another communication group. This may reduce a period in which multi-hop communication is disconnected.

In step S701, the control apparatus 200 determines whether a condition for reorganizing communication groups is satisfied. Hereinafter, this condition will be referred to as a reorganization condition. When the condition for reorganizing communication groups is satisfied (“YES” of step S701), the control apparatus 200 causes processing to proceed to step S702; otherwise (“NO” of step S701), step S701 is repeated.

The reorganization condition may include a state where at least one of a plurality of vehicles that belong to a communication group has arrived at a branch in a road. The branch in the road may include a branch in a highway or an intersection (a cross road or a T-junction). At the branch in the road, there is a possibility that the plurality of vehicles that belong to the communication group take separate courses. Reorganizing communication groups at this timing improves the continuity of communication groups after passing through the branch in the road.

The reorganization condition may include a state where at least one of the plurality of vehicles that belong to the communication group has changed lanes. Lane changing may be an early sign of the separation of courses of the plurality of vehicles that belong to the communication group. In view of this, communication groups may be reorganized at this timing.

The reorganization condition may include a state where a speed of at least one of the plurality of vehicles that belong to the communication group has become equal to or lower than a threshold. This threshold may be a positive value (e.g., 10 km per hour), or may be zero. When the threshold is zero, the reorganization condition includes a state where at least one of the plurality of vehicles that belong to the communication group has been stopped. In general, a vehicle that is about to turn right or turn left at a branch in a road reduces its vehicle speed in preparation for the turn. Therefore, a reduced vehicle speed may be an early sign of the separation of courses of the plurality of vehicles that belong to the communication group. In view of this, communication groups may be reorganized at this timing.

In step S702, the control apparatus 200 obtains vehicle information from each of the plurality of vehicles within the communication group to which the self-vehicle belongs (including the self-vehicle). Furthermore, when one or more other communication groups exist in the surroundings of the communication group to which the self-vehicle belongs, the control apparatus 200 obtains vehicle information from each of a plurality of vehicles that belong to these one or more communication groups. The surroundings of the communication group to which the self-vehicle belongs may refer to a range in which one of the vehicles that belong to this communication group may perform communication directly (e.g., may perform vehicle-to-vehicle communication).

Furthermore, when one or more vehicles that do not belong to a communication group exist in the surroundings of the communication group to which the self-vehicle belongs, the control apparatus 200 obtains vehicle information from each these one or more vehicles.

In step S703, based on the pieces of vehicle information obtained in step S702, the control apparatus 200 determines communication groups to which the plurality of vehicles, from which the pieces of vehicle information have been obtained, belong (i.e., reorganizes communication groups). Vehicles to be involved in the reorganization may include vehicles that are included in the communication group to which the self-vehicle belongs, vehicles that are included in other communication groups, and vehicles that are not included in any communication group. The details of a reorganization method will be described later.

In step S704, with respect to each of the plurality of communication groups after the reorganization, a connection configuration is determined based on the pieces of vehicle information obtained in step S702. The control apparatus 200 notifies each vehicle in the communication groups of the determined connection configuration. A method of determining a connection configuration of a communication group will be described later. Upon receiving the notification of the connection configuration, each vehicle starts multi-hop communication in accordance with this connection configuration. The control apparatus 200 of a vehicle 100 that acts as a root node also starts operations as a management apparatus of the communication group to which the self-vehicle belongs.

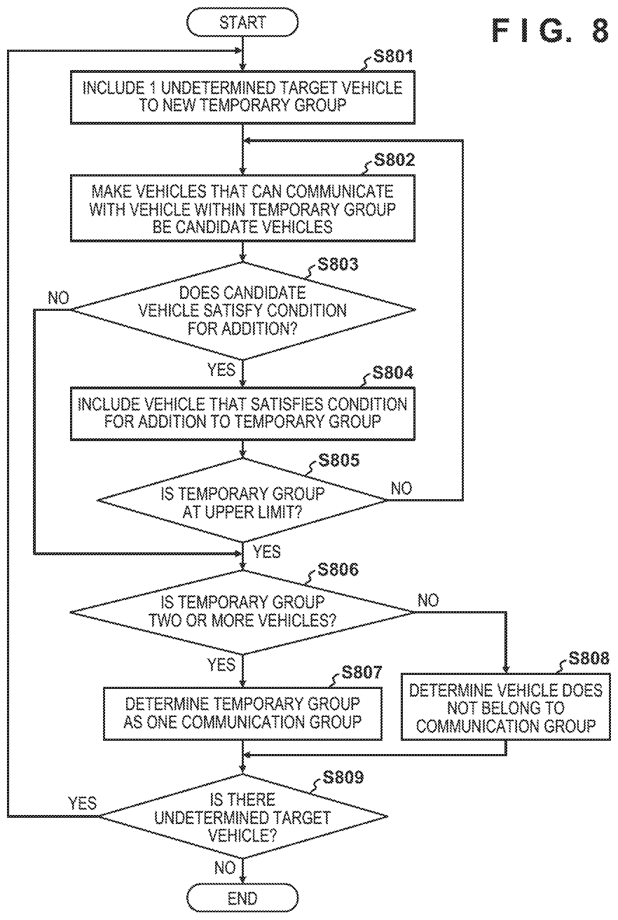

With reference to FIG. 8, the following describes a method of reorganizing communication groups based on vehicle information. Hereinafter, vehicles to be involved in the reorganization will be referred simply to as target vehicles. The reorganization of communication groups is executed in the above-described step S703.

In step S801, the control apparatus 200 arbitrarily selects one of the target vehicles, and includes this target vehicle in a new temporary group. In step S802, the control apparatus 200 regards one or more vehicles which are included among the target vehicles and which may establish a communication link with one of the vehicles included in the temporary group as a candidate vehicle.

In step S803, the control apparatus 200 determines whether there is a candidate vehicle that satisfies a condition for addition to the temporary group. When there is a candidate vehicle that satisfies the condition for addition (“YES” of step S803), the control apparatus 200 causes processing to proceed to step S804; otherwise (“NO” of step S803), processing proceeds to step S806.

The control apparatus 200 determines whether there is a candidate vehicle that satisfies the condition for addition based on the pieces of vehicle information of the vehicles that belong to the temporary group and on the vehicle information of the candidate vehicle. The condition for addition may be based on information related to a course of a vehicle. For example, the condition for addition may include a state where the vehicle to be compared has the same moving direction at a branch, or a state where the route of the vehicle to be compared until the destination is the same partway. The condition for addition may be based on information related to a position of a vehicle. For example, the condition for addition may include a state where the vehicle to be compared is located in the same lane. The condition for addition may be based on information related to a speed of a vehicle. For example, the condition for addition may include a state where the current speed of the vehicle to be compared is within a predetermined range (e.g., different by 5 km per hour or less), or a state where the average speed of the vehicle to be compared in the past (e.g., the average speed thereof in the last hour) is within a predetermined range (e.g., different by 10 km per hour or less).

The condition for addition may be based on information related to people on board a vehicle. For example, the condition for addition may include a state where the composition of people on board the vehicle to be compared is similar (e.g., one person or more than one person, whether a child is included, and whether they are co-workers). The condition for addition may be based on information related to a type of a vehicle. For example, the condition for addition may include a state where the vehicle category of the vehicle to be compared is the same (e.g., whether it is a truck or a passenger vehicle). The condition for addition may include all or only a part of the plurality of specific examples described above.

In step S804, the control apparatus 200 includes the candidate vehicle that satisfies the condition for addition in the temporary group. When there are a plurality of candidate vehicles that satisfy the condition for addition, the control apparatus 200 may include, in the temporary group, a candidate vehicle that satisfies a larger number of conditions among the specific examples described above.

In step S805, the control apparatus 200 determines whether the number of vehicles that belong to the temporary group has reached an upper limit. When the number of vehicles that belong to the temporary group has reached the upper limit (“YES” of step S805), the control apparatus 200 causes processing to proceed to step S806; otherwise (“NO” of step S805), processing proceeds to step S802.

The control apparatus 200 may determine whether the number of vehicles that belong to the temporary group has reached the upper limit based on at least one of information related to the communication apparatuses of vehicles, information related to the speeds of vehicles, and information related to the positions of vehicles. For example, the control apparatus 200 may determine that the number of vehicles that belong to the temporary group has reached the upper limit when a value of a sum of the communication speeds of the communication apparatuses of one or more vehicles that belong to the temporary group has reached a predetermined threshold.

In addition to or in place of the foregoing, the control apparatus 200 may determine that the number of vehicles that belong to the temporary group has reached the upper limit when the number of vehicles that belong to the temporary group has reached a predetermined threshold. This threshold for the number of vehicles may be variable based on information related to the positions of vehicles. For example, when vehicles are traveling in a suburban area, there is a tendency that a following distance between vehicles is long and thus the quality of multi-hop communication is easily degraded compared to when vehicles are traveling in an urban area. Therefore, when vehicles are traveling in a suburban area, the threshold for the upper limit of the number of vehicles may have a small value compared to when vehicles are traveling in an urban area. Similarly, as there is a tendency that a following distance between vehicles is longer for a higher vehicle speed range, the value of the threshold for the upper limit of the number of vehicles may decrease as the vehicle speed (e.g., the average speed in the past) increases.

In step S806, the control apparatus 200 determines whether the temporary group includes two or more target vehicles. When the temporary group includes two or more target vehicles (“YES” of step S806), the control apparatus 200 causes processing to proceed to step S807; otherwise (“NO” of step S806), processing proceeds to step S808.

In step S807, the control apparatus 200 determines the two or more vehicles included in the temporary group as members of one communication group. In step S808, the control apparatus 200 determines that one vehicle included in the temporary group cannot form a communication group with other vehicles. Therefore, this one vehicle cannot continue multi-hop communication.

In step S809, the control apparatus 200 determines whether there is an undetermined target vehicle. When there is an undetermined target vehicle (“YES” of step S809), the control apparatus 200 causes processing to proceed to step S801; otherwise (“NO” of step S809), processing is ended.

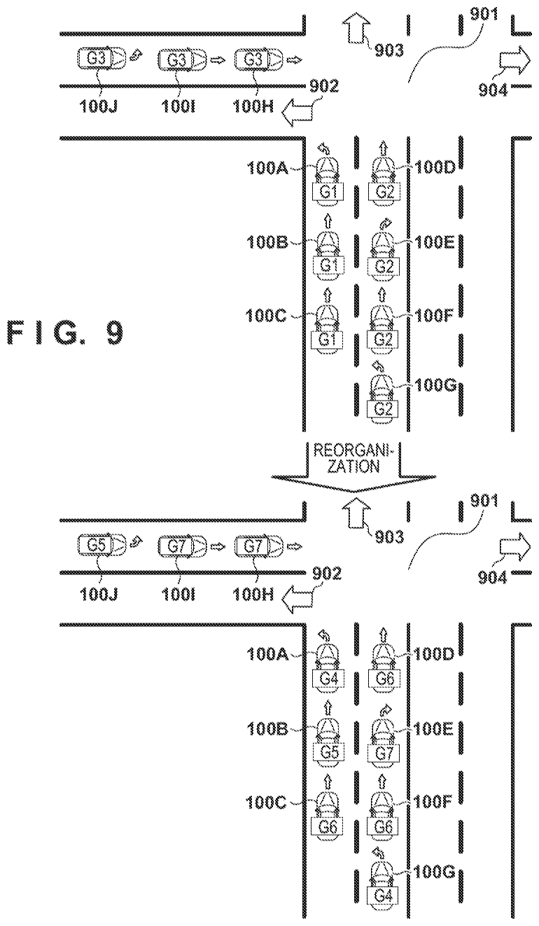

With reference to FIG. 9, the following describes a specific example of a method of reorganizing communication groups based on vehicle information. An upper side of FIG. 9 shows the compositions of a plurality of communication groups G1 to G3 before the reorganization, and a lower side of FIG. 9 shows the compositions of a plurality of communication groups G4 to G7 after the reorganization. A description is now given of the compositions before the reorganization. It is assumed that a plurality of vehicles 100A to 100G are stopped below an intersection 901, and a plurality of vehicles 100J to 100H are traveling on the left of the intersection 901. Three vehicles 100A to 100C in the same lane compose a communication group G1, and four vehicles 100D to 100G in another lane on the same road compose a communication group G2. Also, three vehicles 100H to 100J on another road compose a communication group G3. An arrow provided in front of each vehicle indicates a scheduled moving direction at the intersection 901. That is to say, the vehicles 100A and 100G are scheduled to move in the direction of an arrow 902 at the intersection 901. The vehicles 100B, 100C, 100D, 100F, and 100J are scheduled to move in the direction of an arrow 903 at the intersection 901. The vehicles 100E, 100H, and 100I are scheduled to move in the direction of an arrow 904 at the intersection 901.

A management apparatus in one of the communication groups G1 to G3 starts reorganizing the communication groups in accordance with the arrival of a vehicle within the communication group at the intersection 901. For example, the control apparatus 200 of the vehicle 100A, which functions as a management apparatus in the communication group G1, executes steps S702 to S704 of FIG. 7. The control apparatus 200 of the vehicle 100A regards the plurality of vehicles 100A to 100C within the communication group G1 to which the self-vehicle belongs, as well as the plurality of vehicles 100D to 100J within the communication groups G2 and G3 that exist in the surroundings of the communication group G1, as vehicles to be involved in the reorganization. Although not included in FIG. 9, when a vehicle that is not included in any group exists in the surroundings of the communication group G1, the control apparatus 200 may include this vehicle in the vehicles to be involved in the reorganization.

As a result of performing the reorganization in accordance with the operations of FIG. 8, the vehicles 100A and 100G compose a communication group G4, the vehicles 100B and 100J compose a communication group G5, the vehicles 100C, 100D, and 100F compose a communication group G6, and the vehicles 100E, 100H, and 100I compose a communication group G7.

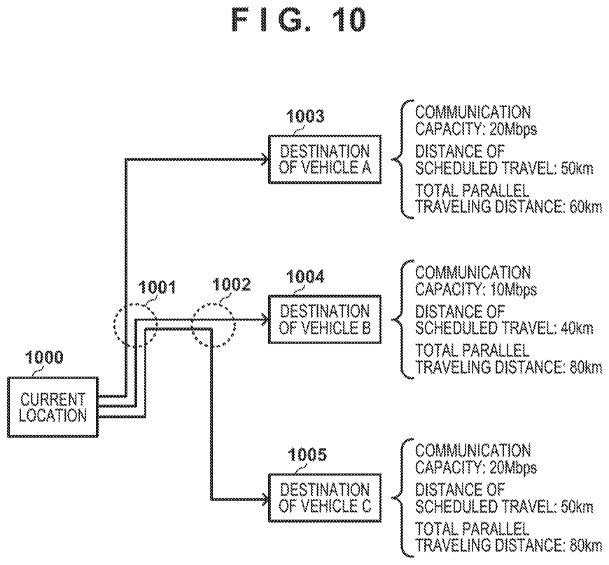

With reference to FIG. 10, the following describes a method of determining a connection configuration based on vehicle information. The determination of the connection configuration is executed in steps S407, S603, and S704 described above. In the present example, it is assumed that a vehicle A, a vehicle B, and a vehicle C compose one communication group. The control apparatus 200 may determine the connection configuration based on at least one of the communication capacities of the communication apparatuses of the vehicles and the length of the parallel traveling distance of the vehicles. The determination of the connection configuration includes determination of a root node of the communication group.

It is assumed that the communication capacity of the communication apparatus of the vehicle A is 20 Mbps, the communication capacity of the communication apparatus of the vehicle B is 10 Mbps, and the communication capacity of the communication apparatus of the vehicle C is 20 Mbps. Furthermore, it is assumed that the distance of scheduled travel from a current location 1000 to a destination 1003 of the vehicle A is 50 km, the distance of scheduled travel from the current location 1000 to a destination 1004 of the vehicle B is 40 km, and the distance of scheduled travel from the current location 1000 to a destination 1005 of the vehicle C is 50 km. It is assumed that the scheduled routes of the three vehicles A to C are the same from the current location 1000 to a certain geographical point 1001 at a distance of 20 km therefrom, and the vehicle A departs from other vehicles at the geographical point 1001. In addition, it is assumed that the scheduled routes of the vehicle B and the vehicle C are the same from the geographical point 1001 to a geographical point 1002 at a distance of 10 km therefrom, and the vehicles B and C depart from each other at the geographical point 1002.

The total parallel traveling distance of each vehicle is defined as a sum of products of the number of vehicles travelling in parallel and the parallel traveling distance. For example, the total parallel traveling distance of the vehicle A is: 20 km (the distance from the current location 1000 to the geographical point 1001)×3 vehicles=60 km. The total parallel traveling distance of each of the vehicle B and the vehicle C is: 20 km (the distance from the current location 1000 to the geographical point 1001)×3 vehicles+10 km (the distance from the geographical point 1001 to the geographical point 1002)×2 vehicles=80 km.

The control apparatus 200 may determine the connection configuration of the communication group by using the following order of priority in making a decision: the total parallel traveling distance, the distance of scheduled travel, and the communication capacity. For example, in order to determine the root node, the control apparatus 200 selects a vehicle with the longest total parallel traveling distance 1 from among the members of the communication group. When there are a plurality of vehicles with the longest total parallel traveling distance, the control apparatus 200 selects a vehicle with the longest distance of scheduled travel, which has the second highest priority. As a result, the vehicle C is determined as the root node. The control apparatus 200 may also determine child nodes of the root node based on a similar standard. As a result, the vehicle B becomes the child node of the vehicle C, and the vehicle A becomes the child node of the vehicle B.

Alternatively, the control apparatus 200 may determine the connection configuration of the communication group by using the following order of priority in making a decision: the communication capacity, the total parallel traveling distance, and the distance of scheduled travel. For example, in order to determine the root node, the control apparatus 200 selects a vehicle with the largest communication capacity from among the members of the communication group. When there are a plurality of vehicles with the largest communication capacity, the control apparatus 200 selects a vehicle with the longest total parallel traveling distance, which has the second highest priority. As a result, the vehicle C is determined as the root node. The control apparatus 200 may also determine child nodes of the root node based on a similar standard. As a result, the vehicle A becomes the child node of the vehicle C, and the vehicle B becomes the child node of the vehicle A.

The foregoing embodiment has been described using an example in which a control apparatus 200 of a vehicle 100 functions as a management apparatus in a communication group. Alternatively, an apparatus that is not included in a vehicle 100, for example, the server 130 of FIG. 1, may function as a management apparatus in a communication group.

### Summary of Embodiment

### <Item 1>

A management apparatus (200) for managing a communication group (110, 111) composed of a plurality of vehicles (100) that each include a communication apparatus (207), the management apparatus comprising:

an obtainment unit (301, 302) configured to obtain vehicle information related to two or more vehicles included in one communication group; and

an organization unit (304) configured to, based on the vehicle information related to the two or more vehicles, reorganize each of the two or more vehicles into one of two or more communication groups.

This item improves the continuity of communication within a communication group of vehicles.

<Item 2>

The management apparatus according to item 1, wherein

the two or more vehicles are two or more first vehicles,

the obtainment unit further obtains vehicle information related to a second vehicle that is not included in the one communication group, and

based further on the vehicle information related to the second vehicle, the organization unit organizes the second vehicle into one of the two or more communication groups.

According to this item, a vehicle that is not included in a communication group of a self-vehicle may be involved in the reorganization.

<Item 3>

The management apparatus according to item 2, wherein

before the second vehicle is organized into one of the two or more communication groups, the second vehicle is included in a communication group different from the one communication group.

According to this item, vehicles in a plurality of communication groups may be involved in the reorganization.

<Item 4>

The management apparatus according to any one of items 1 to 3, wherein

the organization unit reorganizes the two or more vehicles when a speed of at least one of the two or more vehicles has become equal to or lower than a threshold.

According to this configuration, a communication group may be reorganized at a time point when a plurality of vehicles in the communication group are expected to take separate courses.

<Item 5>

The management apparatus according to any one of items 1 to 4, wherein

the organization unit reorganizes the two or more vehicles when at least one of the two or more vehicles has changed lanes.

According to this configuration, a communication group may be reorganized at a time point when a plurality of vehicles in the communication group are expected to take separate courses.

<Item 6>

The management apparatus according to any one of items 1 to 5, wherein

the organization unit reorganizes the two or more vehicles when at least one of the two or more vehicles has arrived at a branch in a road.

According to this configuration, a communication group may be reorganized at a time point when a plurality of vehicles in the communication group are expected to take separate courses.

<Item 7>

The management apparatus according to any one of items 1 to 6, wherein

the vehicle information includes information related to courses of vehicles.

According to this configuration, a communication group may be reorganized so as to improve the continuity of communication within the communication group.

<Item 8>

The management apparatus according to any one of items 1 to 7, wherein

the vehicle information includes information of lanes in which vehicles are located.

According to this configuration, a communication group may be reorganized so as to improve the continuity of communication within the communication group.

<Item 9>

The management apparatus according to any one of items 1 to 8, wherein

the vehicle information includes information related to speeds of vehicles.

According to this configuration, a communication group may be reorganized so as to improve the continuity of communication within the communication group.

<Item 10>

The management apparatus according to any one of items 1 to 9, wherein

the vehicle information includes information related to radio wave bands used by communication apparatuses included in vehicles.

According to this configuration, a communication group may be reorganized so as to improve the continuity of communication within the communication group.

<Item 11>

The management apparatus according to any one of items 1 to 10, wherein

the organization unit determines an upper limit of the number of vehicles included in a communication group based on at least one of information related to communication apparatuses included in vehicles, information related to speeds of vehicles, and information related to positions of vehicles.

According to this configuration, the number of vehicles within a communication group may be set appropriately, and thus the quality of communication within the communication group is improved.

<Item 12>

The management apparatus according to any one of items 1 to 11, wherein

the organization unit determines a root node of a communication group based on communication capacities of communication apparatuses of vehicles.

This configuration increases the capacity of communication between a vehicle within a communication and an external network.

<Item 13>

The management apparatus according to any one of items 1 to 12, wherein

the organization unit determines a root node of a communication group based on a length of a parallel traveling distance of vehicles.

This configuration increases the number of vehicles for which communication is maintained within a communication group.

<Item 14>

A vehicle (100) comprising the management apparatus (200) according to any one of items 1 to 13.

According to this configuration, reorganization of a communication group may be performed within the communication group.

<Item 15>

A program for causing a computer to function as each unit of the management apparatus according to any one of items 1 to 13.

According to this item, the above-described embodiment is provided in the form of a program.

<Item 16>

A method of managing a communication group (110, 111) composed of a plurality of vehicles (100) that each include a communication apparatus (207), the method comprising:

obtaining vehicle information related to two or more vehicles included in one communication group (step S702); and

based on the vehicle information related to the two or more vehicles, reorganizing each of the two or more vehicles into one of two or more communication groups (step S703).

This item improves the continuity of communication within a communication group of vehicles.

The invention is not limited to the foregoing embodiments, and various variations/changes are possible within the spirit of the invention.

What is claimed is:

1. A management apparatus for managing a communication group composed of a plurality of vehicles that each include a communication apparatus, the management apparatus comprising:
a memory for storing computer readable code; and
a processor operatively coupled to the memory, the processor configured to:
obtain vehicle information related to two or more vehicles included in one communication group; and
based on the vehicle information related to the two or more vehicles, reorganize each of the two or more vehicles into one of two or more communication groups.

2. The management apparatus according to claim 1, wherein
the two or more vehicles are two or more first vehicles, and
the processor is further configured to:
obtain vehicle information related to a second vehicle that is not included in the one communication group; and
based further on the vehicle information related to the second vehicle, organize the second vehicle into one of the two or more communication groups.

3. The management apparatus according to claim 2, wherein
before the second vehicle is organized into one of the two or more communication groups, the second vehicle is included in a communication group different from the one communication group.

4. The management apparatus according to claim 1, wherein
the processor is further configured to reorganize the two or more vehicles when a speed of at least one of the two or more vehicles has become equal to or lower than a threshold.

5. The management apparatus according to claim 1, wherein
the processor is further configured to reorganize the two or more vehicles when at least one of the two or more vehicles has changed lanes.

6. The management apparatus according to claim 1, wherein
the processor is further configured to reorganize the two or more vehicles when at least one of the two or more vehicles has arrived at a branch in a road.

7. The management apparatus according to claim 1, wherein
the vehicle information includes information related to courses of vehicles.

8. The management apparatus according to claim 1, wherein
the vehicle information includes information of lanes in which vehicles are located.

9. The management apparatus according to claim 1, wherein
the vehicle information includes information related to speeds of vehicles.

10. The management apparatus according to claim 1, wherein
the vehicle information includes information related to radio wave bands used by communication apparatuses included in vehicles.

11. The management apparatus according to claim 1, wherein
the processor is further configured to determine an upper limit of the number of vehicles included in a communication group based on at least one of information related to communication apparatuses included in vehicles, information related to speeds of vehicles, and information related to positions of vehicles.

12. The management apparatus according to claim 1, wherein
the processor is further configured to determine a root node of a communication group based on communication capacities of communication apparatuses of vehicles.

13. The management apparatus according to claim 1, wherein
the processor is further configured to determine a root node of a communication group based on a length of a parallel traveling distance of vehicles.

14. A vehicle comprising the management apparatus according to claim 1.

15. A method of managing a communication group composed of a plurality of vehicles that each include a communication apparatus, the method comprising:
obtaining vehicle information related to two or more vehicles included in one communication group; and
based on the vehicle information related to the two or more vehicles, reorganizing each of the two or more vehicles into one of two or more communication groups.

16. A non-transitory storage medium for storing a computer program for causing one or more processors to perform the method according to claim 15.
